(19) United States
(12) Patent Application Publication
(10) Pub. No.: US 2015/0077339 A1
(43) Pub. Date: Mar. 19, 2015

(54) INFORMATION PROCESSING DEVICE

(71) Applicant: Funai Electric Co., Ltd., Osaka (JP)

(72) Inventor: Takayuki KATO, Ikoma-shi (JP)

(21) Appl. No.: 14/472,422

(22) Filed: Aug. 29, 2014

(30) Foreign Application Priority Data
Sep. 17, 2013 (JP) 2013-192201

(51) Int. Cl. G06F 3/0354

(52) U.S. Cl. CPC G06F 3/03547; G06F 2203/0338; G06F 2203/0339
USPC 345/157

(57) ABSTRACT

An information processing device includes a position information acquisition unit which acquires, from a remote controller with a touch panel, three-dimensional position information of a pointing implement with respect to the touch panel, a display control unit which moves a cursor on a display screen according to movement of the pointing implement, a movement limiting unit which prohibits movement of the cursor on the display screen when the height of the pointing implement from the touch panel is at or below a predetermined lock threshold value, and a position selecting unit which selects the position of the cursor on the display screen when the pointing implement touches the touch panel when the movement of the cursor is prohibited.

### BACKGROUND OF THE INVENTION

1. Field of the Invention

The present invention relates to an information processing device and particularly to an information processing device that is operated by an input device including a touch panel.

2. Description of the Related Art

Information processing devices have been proposed in the past in which touch panels that are able to detect three-dimensional positions of pointing implements such as fingers and touch pens are used as input devices (for example, see Japanese Patent Application Laid-Open Publication No. 2012-256213). Such a touch panel includes a capacitive-type touch panel and a resistive film-type touch panel disposed in layers, for example.

Capacitive-type touch panels are formed from conductive films. Even when a pointing implement does not touch a capacitive-type touch panel, an electrostatic bond is formed if it is brought close. Therefore, a capacitive-type touch panel can detect the three-dimensional position of a pointing implement based on the change in the electrostatic capacitance between the pointing implement and the conductive film.

On the other hand, resistive film-type touch panels are formed by layering, side by side, a flexible surface film of polyethylene terephthalate (PET) or the like and a liquid crystal glass film on its inner surface. Transparent conductive films are respectively glued to the two films and electrically isolated by inserting a transparent spacer between them. When the pointing implement touches the resistive film-type touch panel, the surface film bends due to the stress caused by the pointing implement, and the surface film and the glass film are partially placed in a conductive state. At this point, the electrical resistance and the potential change according to the position touched by the pointing implement. The position of the pointing implement can be detected from such changes in electrical resistance and potential.

Thus, the three-dimensional position of a pointing implement can be detected not only when the pointing implement is touching the display panel, but also when the pointing implement is not touching the display panel. Because of this, it is possible to move a cursor on the display screen of a display device or the like by moving a pointing implement in a state in which it is floating from a touch panel, for example, and to select an object or the like that is displayed at the position of the cursor displayed on the display screen by causing the pointing implement to touch the touch panel at the desired position.

However, with a conventional touch panel, the touch panel used to detect the position of the pointing implement differs between a state in which the pointing implement is not touching the touch panel and a state in which it is touching. Specifically, the capacitive-type touch panel is used to detect the position of the pointing implement when the pointing implement is not touching the touch panel, while the resistive film-type touch panel is used to detect the position of the pointing implement when the pointing implement is touching the touch panel. For this reason, even if the pointing implement is moved in the direction perpendicular to the touch panel, there may be a shift in some instances in the detected two-dimensional position between a case in which the pointing implement is not touching and a case in which it is touching.

Furthermore, even if the position of the pointing implement is detected using the same touch panel in the state in which the pointing implement is not touching the touch panel and the state in which it is touching the touch panel, the pointing implement may be jiggled by shaking of the user's hand or the like, thus causing the two-dimensional position of the pointing implement to shift when touching the touch panel.

Because of this, there is a problem in that it is difficult to select a position on a display screen desired by the user.

### SUMMARY OF THE INVENTION

Preferred embodiments of the present invention provide an information processing device that accurately selects a position on a display screen that a user desires.

An information processing device according to a preferred embodiment of the present invention includes a position information acquisition unit configured to acquire, from an input device that includes a touch panel, three-dimensional position information of a pointing implement with respect to the touch panel; a display controller configured or programmed to move a cursor on a display screen according to movement of the pointing implement; a movement limiting unit configured to prohibit the movement of the cursor on the display screen when a height of the pointing implement from the touch panel is at or below a predetermined lock threshold value; and a position selecting unit configured to select the position of the cursor on the display screen when the pointing implement touches the touch panel in a state in which the movement of the cursor is prohibited.

With this configuration, cursor movement is prohibited at a point when the height of the pointing implement from the touch panel is at or below a lock threshold value. For this reason, even if the pointing implement subsequently waveringly touches the touch panel due to the effect of handshaking or the like, the two-dimensional position of the pointing implement does not shift from the position at the point at which the height of the pointing implement became the lock threshold value or less. Accordingly, it is possible to accurately select a position on a display screen desired by the user.

For example, the display control unit preferably is configured to move the cursor on the display screen according to the movement of the pointing implement when the height of the pointing implement from the touch panel is greater than the lock threshold value and also at or below a hover threshold value that is greater than the lock threshold value.

This makes it possible to move the cursor on the display screen by moving the pointing implement while maintaining the height of the pointing implement such that the height of the pointing implement from the touch panel is greater than the lock threshold value and also at or below the hover threshold value.

Moreover, the movement limiting unit preferably is configured to permit the cursor to move on the display screen when the pointing implement that was touching the touch panel is moved away from the touch panel even if the height of the pointing implement from the touch panel is at or below the lock threshold value.

With this configuration, even when touching and non-touching of the pointing implement is repeated in the vicinity of the touch panel due to hand jitter or the like, the movement of the cursor is permitted when touched on the second and subsequent times. Because of this, the position selecting unit does not select the cursor position when the touch panel is touched a second or subsequent time.

In addition, the movement limiting unit is preferably configured to prohibit the movement of the cursor on the display screen after a state in which the height of the pointing implement from the touch panel is at or below the lock threshold value has continued for at least a predetermined lock time threshold value.

With this configuration, cursor movement is not prohibited when the pointing implement rapidly touches the touch panel due to an operator error by the user, for example. Therefore, the position selecting unit prevents the cursor position from being selected.

Furthermore, the display control unit preferably is also configured to move an image displayed on the display screen according to the movement of the pointing implement when the pointing implement moves in a state in which the movement of the cursor is prohibited by the movement limiting unit.

This makes it possible to set up a so-called scroll lock that moves an image on the display screen without moving a cursor.

Moreover, the display control unit is preferably configured to change the display mode of the cursor between a state in which the cursor can be moved on the display screen according to the movement of the pointing implement and a state in which the movement of the cursor on the display screen is prohibited by the movement limiting unit.

This allows the user to ascertain from the display mode of the cursor whether or not the cursor is in a movable state.

In specific terms, the display control unit may change at least the shape, color, or size of the cursor between a state in which the cursor can be moved on the display screen according to the movement of the pointing implement and a state in which the movement of the cursor on the display screen is prohibited by the movement limiting unit.

In addition, the information processing device preferably also includes an unlocking unit configured to stop processing performed by the movement limiting unit and cause the position selecting unit to select the position of the cursor on the display screen when the pointing implement touches the touch panel in a state in which the movement of the cursor is permitted.

This makes it possible to release the mode that prohibits cursor movement as the user desires.

Furthermore, the information processing device preferably also includes a threshold value changing unit configured to change the lock threshold value.

This makes it possible to change the lock threshold value according to the user's preferences.

Moreover, the information processing device preferably also includes a processing execution unit configured to execute processing linked to the position selected by the position selecting unit.

For instance, when an object image is displayed at the selected position, the processing execution unit is preferably configured to execute an application program linked to this object image.

Note that various preferred embodiments of the present invention can not only be realized as an information processing device that includes such a characteristic processing unit, but can also be realized as an information processing method whose steps are processes executed by the characteristic processing unit included in the information processing device. In addition, preferred embodiments of the present invention can also be realized as a non-transitory computer readable medium including a computer program for making a computer function as the characteristic processing unit included in the information processing device or as a non-transitory computer readable medium including a computer program that makes a computer execute characteristic steps that are included in the information processing method. Furthermore, the computer readable medium can be a computer-readable, non-temporary recording media such as a CD-ROM (compact disc read-only memory) or a computer program transmitted over a communications network such as the Internet.

Various preferred embodiments of the present invention make it possible to provide an information processing device that accurately selects a position on a display screen desired by the user.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external appearance diagram of the information processing system according to preferred embodiment 1 of the present invention.

FIG. 2 is a diagram showing one example of an application that uses the information processing system.

FIG. 3 is a diagram showing another example of an application that uses the information processing system.

FIG. 4 is a block diagram showing the functional configuration of the information processing system.

FIG. 5 is a diagram for illustrating the position coordinates of a finger.

FIG. 6 is a diagram for illustrating the lock region and the hover region.

FIG. 7A is a diagram showing the movement of the finger on the touch panel.

FIG. 7B is a diagram showing the movement of the hover cursor on the display screen.

FIGS. 8A-8C include diagrams showing changes in the display mode of the cursor, wherein FIG. 8A is a diagram showing the hover cursor, FIG. 8B is a diagram showing the lock cursor, and FIG. 8C is a diagram showing the selection cursor.

FIG. 9 is a state transition diagram showing the states of the STB.

FIG. 10 is a diagram showing one example of the movement of the finger.

FIG. 11A is a diagram showing one example of the movement of the finger on the touch panel.

FIG. 11B is a diagram showing one example of the movement of the finger on the touch panel.

FIGS. 12A and 12B include diagrams showing the movement of object images on the display screen, wherein FIG. 8A is a diagram showing object images displayed on the display screen before moving the finger, and FIG. 8B is a diagram showing object images displayed on the display screen after moving the finger.

### DETAILED DESCRIPTION OF THE PREFERRED EMBODIMENTS

Preferred embodiments of the present invention will be described in detail below using drawings. Note that each of the preferred embodiments to be described below represents preferred specific examples of the present invention. The numerical values, shapes, materials, constituent elements, the disposed positions and connection modes of the constituent elements, steps, the sequence of steps, and so forth indicated in the preferred embodiments below are just examples and not the main purport that limits the present invention. The present invention is specified by the scope of the claims. Therefore, those constituent elements not recited in the independent claims that are among the constituent elements in the preferred embodiments below are not necessarily required in the present invention.

### Preferred Embodiment 1

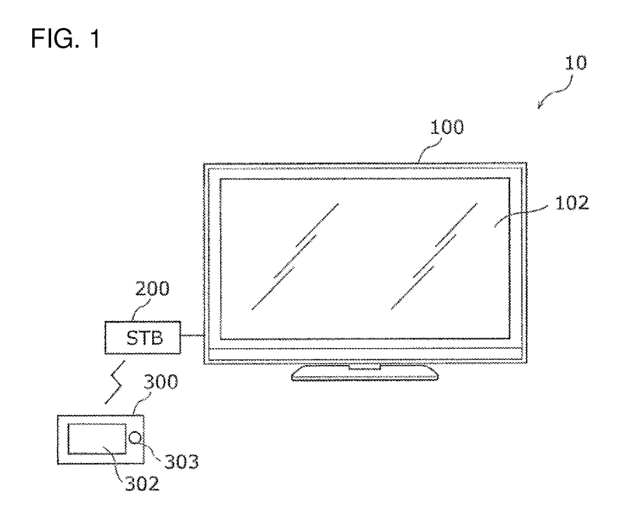

FIG. 1 is an external appearance diagram of the information processing system according to preferred embodiment 1 of the present invention.

The information processing system 10 preferably includes a display device 100, a set-top box (STB) 200, and a remote controller 300.

The display device 100 includes a display screen 102 that displays images, video, and the like.

The STB 200 is connected to the display device 100, executes various types of information processing, and displays execution results on the display screen 102 of the display device 100.

The remote controller 300 is one example of an input device. The remote controller 300 includes a touch panel 302 and sends the three-dimensional position information of the user's finger to the STB 200 by wireless communications by the user's finger operating the touch panel 302. The STB 200 performs selection of objects displayed on the display screen 102, switching of processing, and the like, based on the finger position information sent by the remote controller 300.

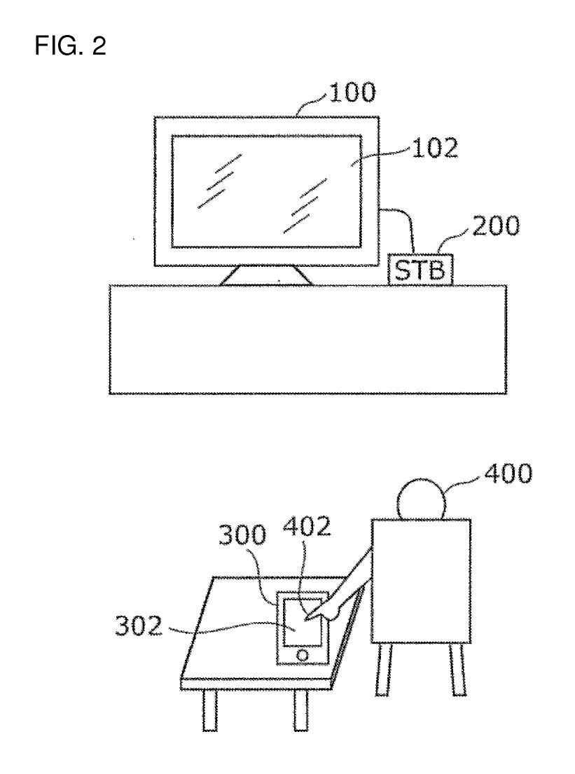

FIG. 2 is a diagram showing one example of an application that uses the information processing system 10.

The information processing system 10 is preferably used in a residential living room, for example. For example, the display device 100 is a television that is ordinarily used by a user 400, and the STB 200 is connected to the display device 100. The user 400 can remotely operate the STB 200 by operating the touch panel 302 of the remote controller 300 held in hand using a finger 402 even without looking at the display screen 102 of the display device 100.

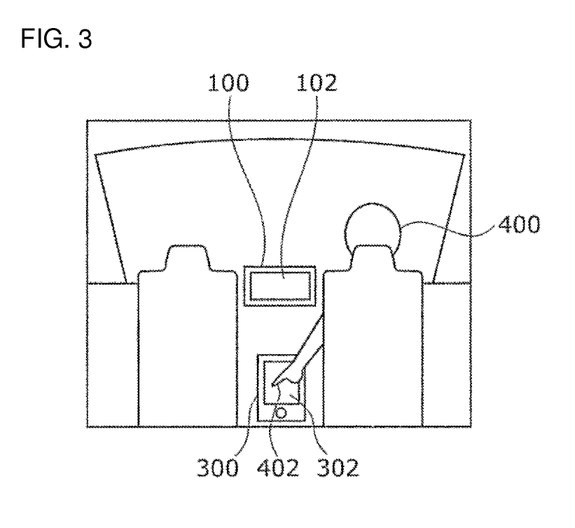

FIG. 3 is a diagram showing another example of an application that uses the information processing system 10.

The information processing system 10 preferably is used in an automobile, for example. For example, the display device 100 is the display device of a car navigation system that the user 400 uses. Note that, in this example, the display device 100 is assumed to be equipped with all of the functions of the STB 200. The user 400 can remotely operate the display device 100 (car navigation system) by operating the touch panel 302 of the remote controller 300 held in hand using the finger 402 even without looking at the display screen 102 of the display device 100 while driving the automobile.

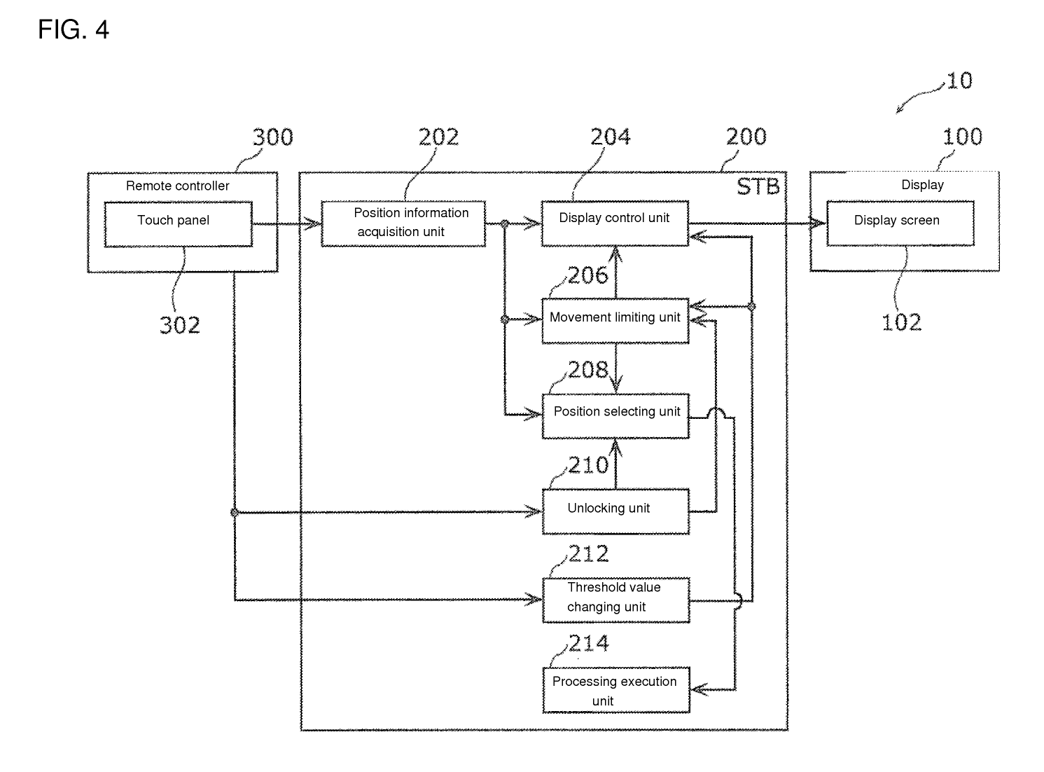

FIG. 4 is a block diagram showing the functional configuration of the information processing system 10.

As was described above, the display device 100 includes a display screen 102, and the remote controller 300 has a touch panel 302.

The STB 200 preferably includes a position information acquisition unit 202, a display control unit 204, a movement limiting unit 206, a position selecting unit 208, an unlocking unit 210, a threshold value changing unit 212, and a processing execution unit 214.

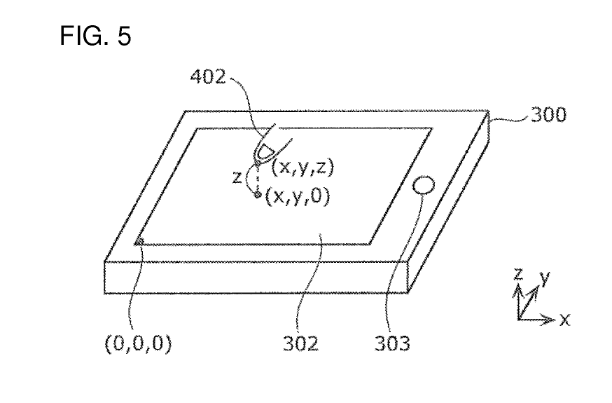

The position information acquisition unit 202 acquires from the remote controller 300 the three-dimensional position information of the user's finger relative to the touch panel 302. For example, as shown in FIG. 5, the direction of width, the direction of depth, and the direction of height of the remote controller 300 are respectively set as the X direction, the Y direction, and the Z direction, and the coordinates of the lower-left corner of the touch panel 302 are set as (0, 0, 0). The position information acquisition unit 202 acquires the three-dimensional coordinates (X, Y, Z) of the finger 402 from the remote controller 300. Note that the touch panel 302 may also be configured of a capacitive-type touch panel and a resistive film-type touch panel disposed in layers as in the past. In this case, when the finger 402 is not touching the touch panel 302, the three-dimensional position of the finger 402 is detected by changes in capacitance in the capacitive-type touch panel. Meanwhile, when the finger 402 has touched the touch panel 302, the position of the finger 402 on the touch panel 302 is detected by changes in the electrical resistance or potential in the resistive film-type touch panel. The Z coordinate of the finger 402 at this point is 0.

Looking again at FIG. 4, the display control unit 204 moves the cursor on the display screen 102 of the display device 100 according to the movement of the finger indicated by the position information acquired by the position information acquisition unit 202. Note that the X and Y coordinates of the finger 402 that the touch panel 302 can sense are assigned a correspondence in advance to X and Y coordinates on the touch panel 302. Therefore, the display control unit 204 moves the cursor in a relative fashion on the display screen 102 as a result of the finger 402 being moved on the touch panel 302.

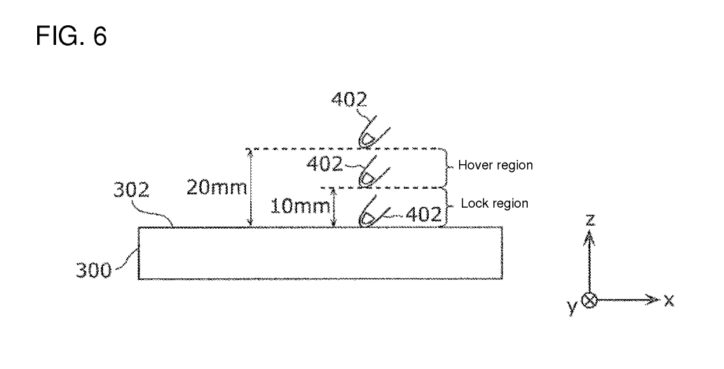

The display control unit 204 is configured or programmed to display on the display screen 102 any one of the following cursors, which will be described below: hover cursor, lock cursor, and selection cursor. As shown in FIG. 6, in order to change the cursor to be displayed according to the position of the finger 402, threshold values for height (a lock threshold value and a hover threshold value) are set with the touch panel 302 being used as a reference. The lock threshold value preferably is about 10 mm, for example, and the hover threshold value preferably is about 20 mm, for example. The region with a height from the touch panel 302 that is greater than the lock threshold value but at or below the hover threshold value is set as the hover region, and the region with a height from the touch panel 302 that is greater than zero but no greater than the lock threshold value is set as the lock region.

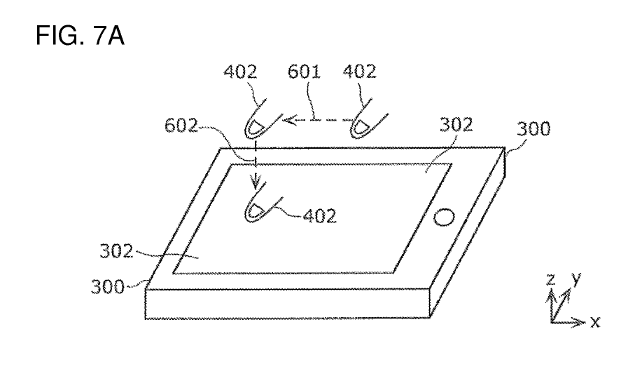

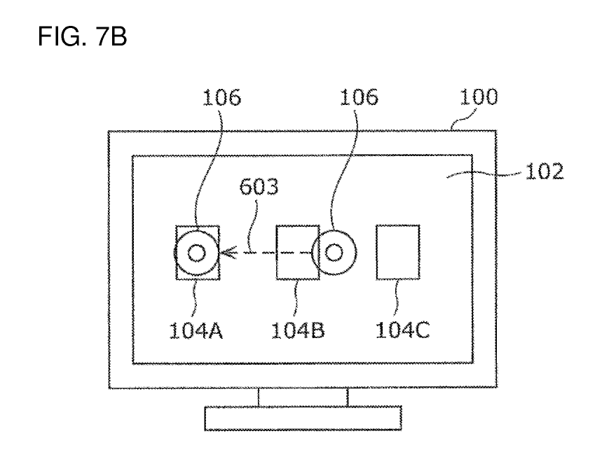

When the finger 402 is in the hover region, the display control unit 204 displays the hover cursor on the display screen 102 and moves the hover cursor on the display screen 102 according to the movement of the finger 402. For instance, when the finger 402 which is in the hover region is moved in the direction from the right to the left as indicated by an arrow 601 as shown in FIG. 7A, the display control unit 204 moves a hover cursor 106 on the display screen 102 in the direction from the right to the left as indicated by an arrow 603 as shown in FIG. 7B.

Looking again at FIG. 4, the movement limiting unit 206 prohibits movement of the cursor on the display screen 102 when the finger 402 is in the lock region. Note that the movement limiting unit 206 may prohibit cursor movement after the lock time threshold value or more has elapsed while the finger 402 is in the lock region.

The position selecting unit 208 selects the position of the cursor on the display screen 102 when the finger 402 touches the touch panel 302 in a state in which cursor movement is prohibited by the movement limiting unit 206.

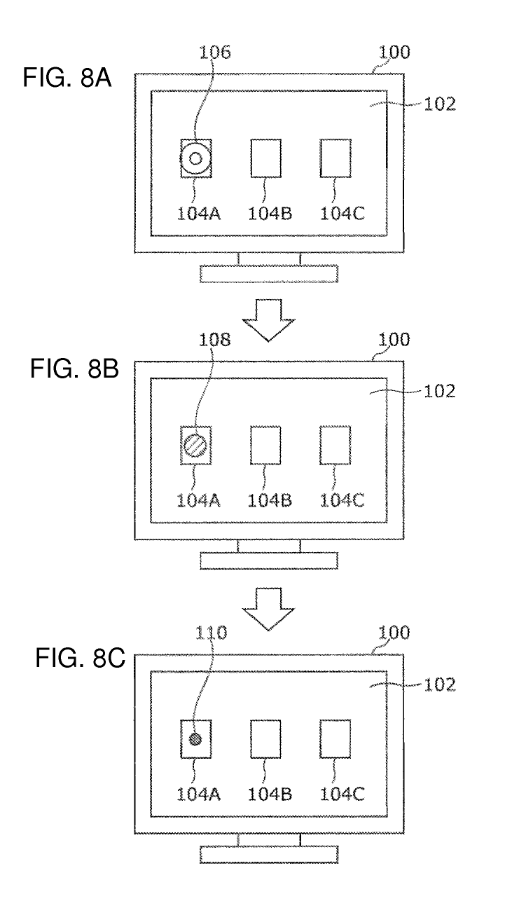

For example, the finger 402 which is in the hover region as shown in FIG. 7A is moved until the finger 402 touches the touch panel 302 as indicated by an arrow 602. As a result of this movement, the finger 402 moves from the hover region to the lock region and ultimately touches the touch panel 302. In this case, when the finger 402 is in the hover region, the display control unit 204 displays the hover cursor 106 on the display screen 102 as shown in FIG. 8A. If the finger 402 is subsequently moved closer to the touch panel 302 and starts to enter the lock region, then the display control unit 204 displays a lock cursor 108 on the display screen 102 as shown in FIG. 8B. Note that cursor movement on the display screen 102 is prohibited by the movement limiting unit 206 at this point, so even if the finger 402 is moved to the left and right within the lock region, the position of the lock cursor 108 on the display screen 102 does not change. If the finger 402 touches the touch panel 302 thereafter, the position selecting unit 208 selects the position of the cursor on the display screen 102. Because the movement of the lock cursor 108 is prohibited as shown in FIG. 8B, the position on the display screen 102 of the lock cursor 108 whose movement is prohibited is selected by the position selecting unit 208. At this point, the display control unit 204 causes a selection cursor 110 to be displayed at the same position as the lock cursor 108 as shown in FIG. 8C in order to show that the finger 402 has touched the touch panel 302. The object image 104A at the left edge is selected from among the three object images 104A through 104C displayed on the display screen 102 by this sort of operation. Note that the hover cursor 106, the lock cursor 108, and the selection cursor 110 have display modes that are different from each other. In specific terms, they will differ in at least shape, color, or size.

Looking again at FIG. 4, the unlocking unit 210 halts processing of the movement limiting unit 206. Specifically, when the finger 402 is moved away from the lock region, the hover cursor is displayed instead of the lock cursor, and the hover cursor moves according to the movement of the finger 402. Furthermore, when the finger 402 touches the touch panel 302 in a state in which the movement of the cursor is permitted, the unlocking unit 210 causes the position selecting unit 208 to select the position of the cursor on the display screen 102. To with, once processing is executed by the unlocking unit 210, the touch panel 302 functions as a general touch panel that has a hover region but does not have a lock region. The mode that prohibits cursor movement is capable of being released in this manner as the user desires. It is also possible to have the mode be released by the pressing of a button 303 provided on the remote controller 300.

The threshold value changing unit 212 changes the lock threshold value. For example, the threshold value changing unit 212 preferably changes the lock threshold value from about 10 mm to about 12 mm based on the operation of the remote controller 300 by the user. Thus, the lock threshold value is capable of being changed according to the user's preferences.

The processing execution unit 214 executes processing linked to the position on the display screen 102 selected by the position selecting unit 208. For example, when an object image is displayed at this position, the processing execution unit 214 executes an application program linked to this object image. Moreover, when a button is displayed at this position, the processing execution unit 214 executes processing linked to this button.

The processing executed by the information processing system 10 will now be described.

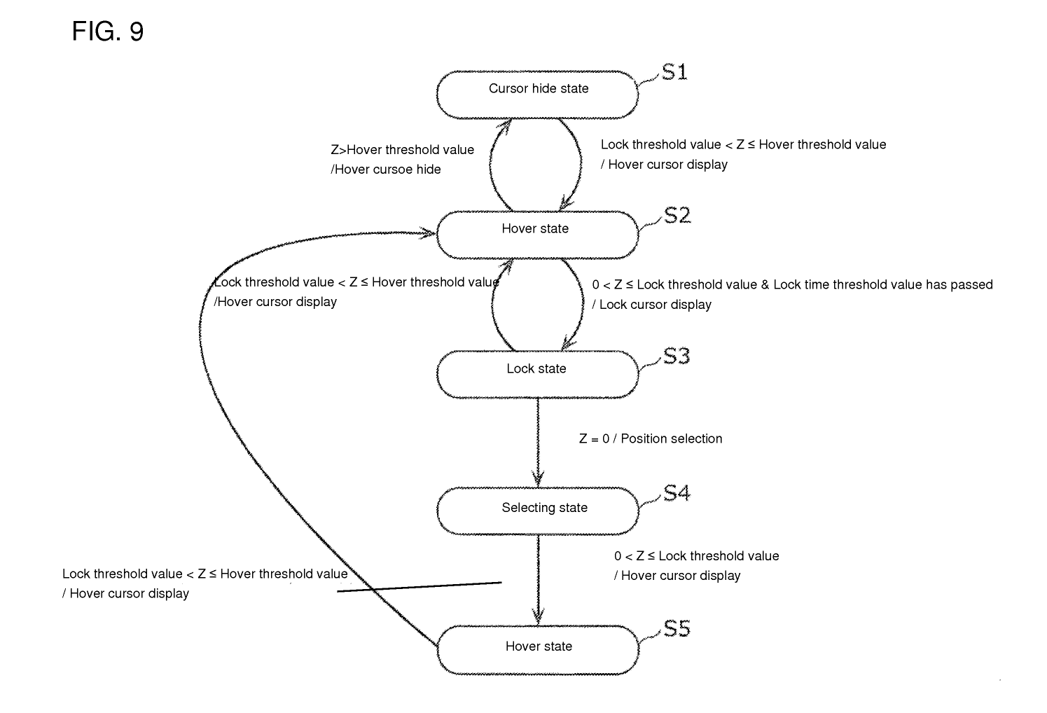

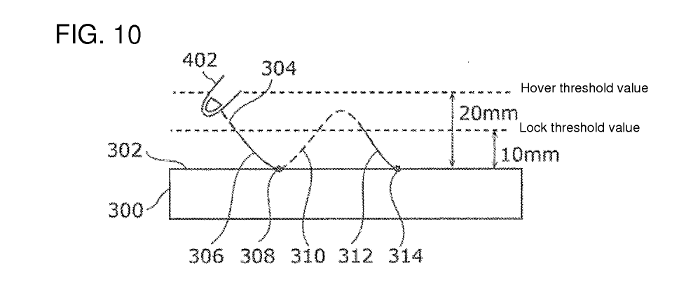

FIG. 9 is a state transition diagram showing the states of the STB 200. FIG. 10 is a diagram showing one example of the movement of the finger 402.

In a state in which the height (Z coordinate) of the finger 402 from the touch panel 302 is greater than the hover threshold value, no cursor is displayed on the display screen 102 (cursor hide state S1). When the finger 402 enters the hover region from the cursor hide state S1 as indicated by the movement trajectory 304 in FIG. 10, that is, when the Z coordinate of the finger 402 is greater than the lock threshold value but at or below the hover threshold value, the display control unit 204 causes the hover cursor to be displayed at the X and Y coordinates on the display screen 102 that correspond to the X and Y coordinates of the finger 402, and the STB 200 transitions to a hover state S2. In S2, the display control unit 204 causes the hover cursor to move on the display screen 102 according to the movement of the finger 402.

When the finger 402 is moved in a direction away from the touch panel 302 from the hover state S2 and the Z coordinate of the finger 402 exceeds the hover threshold value, the display control unit 204 places the hover cursor that is displayed on the display screen 102 into the hide state, and the STB 200 transitions into the cursor hide state S1.

When the finger 402 moves into the lock region from the hover state S2 as indicated by the movement trajectory 306 in FIG. 10, and also a state in which the finger 402 is in the lock region lasts for at least the lock time threshold value, the display control unit 204, at this point, causes the lock cursor to be displayed at the X and Y coordinates on the display screen 102 that correspond to the X and Y coordinates of the finger 402. In addition, the movement limiting unit 206 prohibits movement of the lock cursor. Consequently, the STB 200 transitions to a lock state S3. In the lock state, the lock cursor on the display screen 102 does not move even if the finger 402 is moved.

When the finger 402 moves into the hover region from the lock state S3, the display control unit 204 causes the hover cursor to be displayed again instead of the lock cursor, and the STB 200 transitions into the hover state S2.

When the finger 402 is caused to touch a touch position 308 of the touch panel 302 from the lock state S3 as shown in FIG. 10, that is, when the Z coordinate of the finger 402 becomes 0, the position selecting unit 208 selects the position of the lock cursor that is displayed on the display screen 102. Furthermore, the display control unit 204 displays the selection cursor at the selected position. As a result, the STB 200 transitions to a selecting state S4. In the selecting state S4, the processing execution unit 214 executes processing according to the selected position. For example, when an object image assigned a correspondence to an application program is displayed at the selected position, the processing execution unit 214 executes an application program linked to this object image.

When the finger 402 moves away from the touch panel 302 and into the lock region from the selecting state S4, the STB 200 does not transition into the lock state S3. Specifically, the display control unit 204 causes the hover cursor to be displayed on the display screen 102, and the STB 200 transitions into a hover state S5. By doing so, the cursor position is not selected when touched on the second and subsequent times even when touching and non-touching of the finger 402 is repeated in the vicinity of the touch panel 302 due to hand jitter or the like, for example. Note that in order to have the cursor position be selected again, the finger 402 is caused to move into the hover region as indicated by the movement trajectory 310 of FIG. 10, after which the finger 402 is caused to move into the lock region again as indicated by the movement trajectory 312, and the finger 402 is caused to touch a touch position 314 of the touch panel 302. When the finger 402 moves into the hover region from the hover state S5, the display control unit 204 causes the hover cursor to be displayed on the display screen 102, and the STB 200 transitions into the hover state S2. By moving the finger 402 thereafter as described above, the STB 200 can be transitioned in a manner such as the hover state S2, the lock state S3, and the selecting state S4. Consequently, the position of the cursor can be selected again.

As was described above, with preferred embodiment 1, cursor movement is prohibited at the time when the height of the finger 402 from the touch panel 302 becomes a lock threshold value or less. Therefore, even when the finger 402 waveringly touches the touch panel 302 thereafter because of the effect of handshaking or the like, the two-dimensional position of the finger 402 does not shift from the position at the point at which the height of the finger 402 became the lock threshold value or less. Accordingly, it is possible to accurately select a position desired by the user on the display screen.

Moreover, cursor movement is not prohibited unless the lock time threshold value or more has passed since the finger 402 entered the lock region. For this reason, cursor movement is not prohibited when the finger 402 rapidly touches the touch panel 302 due to an operation error by the user. Because of this, the position selecting unit 208 prevents the position of the cursor from being selected.

In addition, the display modes of the hover cursor, lock cursor, and selection cursor differ from each other. Because of this, the user can ascertain from the display mode of the cursor whether or not the cursor is in a movable state.

### Preferred Embodiment 2

In preferred embodiment 2, just as in preferred embodiment 1, the STB which prevents the cursor from moving when a finger enters the lock region will be described. In preferred embodiment 2, however, when the finger is moved in the lock region, the display position of the cursor does not move, but the image displayed on the display screen moves.

The configuration of the information processing system 10 is similar to that of preferred embodiment 1. Therefore, the detailed description thereof will not be repeated here.

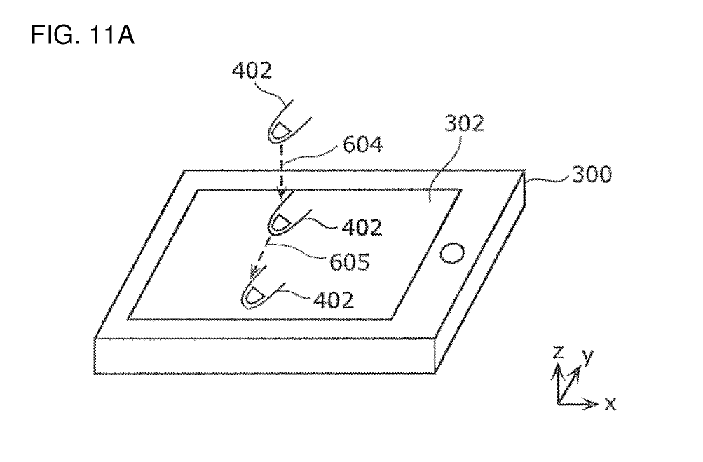

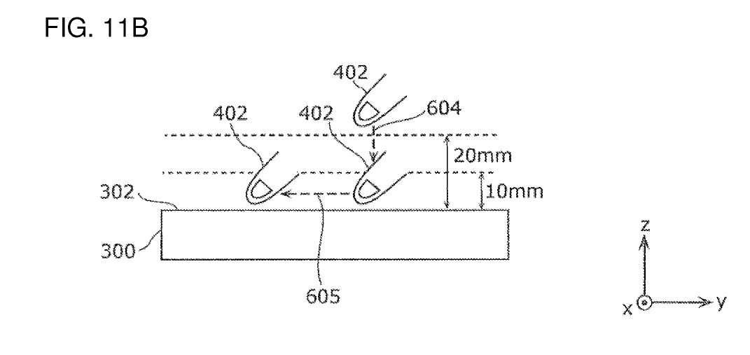

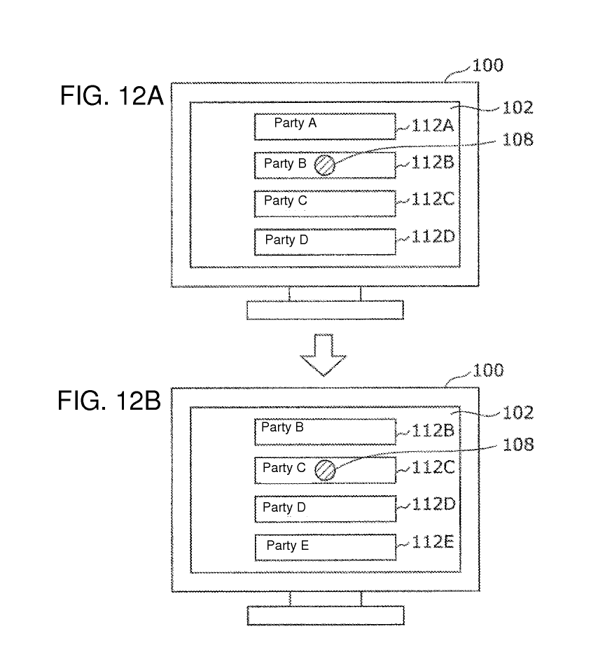

FIGS. 11A and 11B are diagrams showing one example of the movement of the finger 402 on the touch panel 302. FIGS. 12A and 12B are diagrams showing one example of images displayed on the display screen 102 in accordance with the movement of the finger 402.

When the finger 402 is moved into the lock region as indicated by a movement trajectory 604, the display control unit 204 displays the lock cursor 108 at the X and Y coordinates on the display screen 102 that correspond to the X and Y coordinates of the finger 402 as shown in FIG. 12A. Here, a telephone book application software is executed in the STB 200, and object images 112A through 112D that corresponds to parties registered in the telephone book are displayed on the display screen 102. In the present preferred embodiment, a system is envisioned in which a party to whom to place a telephone call is selected by the user operating the remote controller 300 from a telephone book displayed on the display device 100 in an automobile as that shown in FIG. 3, and a call is placed automatically to the selected party.

When the finger 402 is moved in the Y direction, for example, within the lock region as indicated by the movement trajectory 605 in FIGS. 11A and 11B, the movement of the lock cursor 108 is limited as shown in FIG. 12B, but the image displayed on the display screen 102 scrolls. Specifically, the display control unit 204 scrolls the object images up by one each and displays the object images 112B through 112E.

A so-called scroll lock that moves an image without moving the cursor on the display screen can be set as described above according to preferred embodiment 2.

The information processing systems according to the preferred embodiments of the present invention were described above, but the present invention is in no way limited to these preferred embodiments.

For instance, in the preferred embodiments, the touch panel 302 preferably was operated by the finger 402, for example, but it is also possible to operate the touch panel 302 with a touch pen.

Furthermore, the respective devices described above may also be configured as a computer system including, in concrete terms, a microprocessor, ROM, RAM, hard disk drive, display unit, keyboard, mouse, and the like. A computer program is stored in the RAM or hard disk drive. The individual devices achieve their functions by the microprocessor operating in accordance with the computer program. Here, the computer program is preferably configured by combining a plurality of instruction codes that represent instructions to the computer in order to achieve specified functions.

Moreover, some or all of the constituent elements that configure the individual devices may also be configured from a single system LSI (large-scale integrated circuit). A system LSI is an ultra-multifunction LSI fabricated by integrating a plurality of constituent elements or units on a single chip; in concrete terms, it is a computer system that is configured by including a microprocessor, ROM, RAM, and the like. A computer program is stored in the RAM. The system LSI achieves and performs its functions by the microprocessor operating according to the computer program.

In addition, some or all of the constituent elements that configure the various devices may also be configured from an IC card or unitary module that can be mounted and unmounted from the devices. The IC card or module is a computer system configured from a microprocessor, ROM, RAM, and the like. The IC card or module may include the ultra-multifunction LSI. The IC card or module achieves its functions by the microprocessor operating in accordance with a computer program. This IC card or module may have tamperproof properties.

Furthermore, various preferred embodiments of the present invention may also be constituted by the method described above. Moreover, various preferred embodiments of the present invention may also be constituted by a non-transitory computer readable medium including a computer program that realizes and performs these methods using computers and may also be a digital signal composed of the computer program.

In addition, various preferred embodiments of the present invention may be something that records the computer program or the digital signal on a computer-readable, non-temporary recording medium, such as a flexible disc, hard disk, CD-ROM, magneto-optical disc, DVD, DVD-ROM, DVD-RAM, Blu-ray (registered trademark) disc, and semiconductor memory. Furthermore, it may also be the digital signal that is recorded on these non-temporary recording media.

Moreover, various preferred embodiments of the present invention may be a device, apparatus or method that transfers the computer program or the digital signal over a telecommunications line, a wireless or wired communications line, a network (typically the Internet), data broadcasting, or the like.

In addition, various preferred embodiments of the present invention may be a computer system equipped with a microprocessor and memory, with the memory storing the computer program, and the microprocessor operating in accordance with the computer program.

Furthermore, various preferred embodiments of the present invention may be implemented by another independent computer system by storing the program or the digital signal on the non-temporary recording medium and transferring it or by transferring the program or the digital signal over the network or the like.

Various preferred embodiments of the present invention can be applied as an information processing device and information processing system in a car navigation system, STB, or the like that selects object images using a touchpad remote controller.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing device comprising:
a position information acquisition unit configured to acquire, from an input device including a touch panel, three-dimensional position information of a pointing implement with respect to the touch panel;
a display control unit configured or programmed to move a cursor on a display screen according to movement of the pointing implement;
a movement limiting unit configured to prohibit movement of the cursor on the display screen when a height of the pointing implement from the touch panel is at or below a predetermined lock threshold value; and
a position selecting unit configured to select a position of the cursor on the display screen when the pointing implement touches the touch panel in a state in which the movement of the cursor is prohibited.

2. The information processing device according to claim 1, wherein the display control unit is configured or programmed to move the cursor on the display screen according to the movement of the pointing implement when the height of the pointing implement from the touch panel is greater than the lock threshold value and also at or below a hover threshold value that is greater than the lock threshold value.

3. The information processing device according to claim 2, wherein the movement limiting unit is configured to permit the cursor to move on the display screen when the pointing implement that was touching the touch panel is moved away from the touch panel even if the height of the pointing implement from the touch panel is at or below the lock threshold value.

4. The information processing device according to claim 1, wherein the movement limiting unit is configured to prohibit the movement of the cursor on the display screen after a state in which the height of the pointing implement from the touch panel is at or below the lock threshold value has continued for at least a predetermined lock time threshold value.

5. The information processing device according to claim 1, wherein the display control unit is configured or programmed to move an image displayed on the display screen according to the movement of the pointing implement when the pointing implement moves in a state in which the movement of the cursor is prohibited by the movement limiting unit.

6. The information processing device according to claim 1, wherein the display control unit is configured or programmed to change the display mode of the cursor between a state in which the cursor can be moved on the display screen according to the movement of the pointing implement and a state in which the movement of the cursor on the display screen is prohibited by the movement limiting unit.

7. The information processing device according to claim 6, wherein the display control unit is configured or programmed to change at least a shape, color, or size of the cursor between a state in which the cursor can be moved on the display screen according to the movement of the pointing implement and a state in which the movement of the cursor on the display screen is prohibited by the movement limiting unit.

8. The information processing device according to claim 1, further comprising an unlocking unit configured to stop processing performed by the movement limiting unit and cause the position selecting unit to select the position of the cursor on the display screen when the pointing implement touches the touch panel in a state in which the movement of the cursor is permitted.

9. The information processing device according to claim 1, further comprising a threshold value changing unit configured to change the lock threshold value.

10. The information processing device according to claim 1, further comprising a processing execution unit configured to execute processing linked to the position selected by the position selecting unit.

11. A method of processing information comprising:
acquiring from an input device including a touch panel three-dimensional position information of a pointing implement with respect to the touch panel;
moving a cursor on a display screen according to movement of the pointing implement;
prohibiting movement of the cursor on the display screen when a height of the pointing implement from the touch panel is at or below a predetermined lock threshold value; and
selecting a position of the cursor on the display screen when the pointing implement touches the touch panel in a state in which the movement of the cursor is prohibited.

12. The method according to claim 11, further comprising moving the cursor on the display screen according to the movement of the pointing implement when the height of the pointing implement from the touch panel is greater than the lock threshold value and also at or below a hover threshold value that is greater than the lock threshold value.

13. The method according to claim 12, further comprising permitting the cursor to move on the display screen when the pointing implement that was touching the touch panel is moved away from the touch panel even if the height of the pointing implement from the touch panel is at or below the lock threshold value.

14. The method according to claim 11, further comprising prohibiting the movement of the cursor on the display screen after a state in which the height of the pointing implement from the touch panel is at or below the lock threshold value has continued for at least a predetermined lock time threshold value.

15. The method according to claim 11, further comprising moving an image displayed on the display screen according to the movement of the pointing implement when the pointing implement moves in a state in which the movement of the cursor is prohibited.

16. The method according to claim 11, further comprising changing the display mode of the cursor between a state in which the cursor can be moved on the display screen according to the movement of the pointing implement and a state in which the movement of the cursor on the display screen is prohibited.

17. The method according to claim 16, further comprising changing at least a shape, color, or size of the cursor between a state in which the cursor can be moved on the display screen according to the movement of the pointing implement and a state in which the movement of the cursor on the display screen is prohibited.

18. The method according to claim 11, further comprising selecting the position of the cursor on the display screen when the pointing implement touches the touch panel in a state in which the movement of the cursor is permitted.

19. The method according to claim 11, further comprising changing the lock threshold value.

20. The method according to claim 11, further comprising performing processing linked to the position selected in the step of selecting.
